(19) United States
(12) Patent Application Publication
(10) Pub. No.: US 2015/0163858 A1
(43) Pub. Date: Jun. 11, 2015

(54) JOULE HEATING APPARATUS AND METHOD

(71) Applicant: Save The World Air, Inc., Santa Barbara, CA (US)

(72) Inventors: Carl D. Meinhart, Santa Barbara, CA (US); Bjorn D. H. Simundson, Santa Barbara, CA (US)

(21) Appl. No.: 14/562,668

(22) Filed: Dec. 6, 2014

Related U.S. Application Data
(60) Provisional application No. 61/912,917, filed on Dec. 6, 2013.

(51) Int. Cl. H05B 3/00; H05B 3/02

(52) U.S. Cl. CPC H05B 3/0009; H05B 3/023

(57) ABSTRACT

A Joule heating apparatus with a housing having an internal cavity. The housing has an inlet portal for introducing fluid into the internal cavity and an outlet portal for discharging the fluid form the internal cavity. The internal cavity includes an internal heating section with at least one electrode assembly. The electrode assembly has a supply electrode, a ground electrode, and a space between the supply and ground electrodes. The space of the electrode assembly is in fluid communication with the housing's inlet and outlet portals. The electrode assembly is adapted to form an electric field to heat via Joule heating the fluid flowing through the annulus. A method for Joule heating of a fluid is provided that uses the aforesaid apparatus to heat the fluid by applying an electric field thereto.

### CROSS-REFERENCE TO RELATED APPLICATIONS

This application claims the benefit of and priority to U.S. Provisional Application No. 61/912,917, filed on Dec. 6, 2013, which is incorporated herein by reference.

### BRIEF DESCRIPTION OF THE DRAWINGS

FIG. 1A is a diagram illustrating a trace heating mechanism.

FIG. 1B is a diagram illustrating the Joule heating mechanism.

FIG. 2 is a side view of an embodiment of the invention.

FIG. 3 is a cut-away view of the embodiment of the invention shown in FIG. 2.

FIG. 4 is a cross-sectional view of the embodiment of the invention shown in FIG. 2.

FIG. 5 is a perspective view of an embodiment of an electrode assembly of the invention.

FIG. 6 is a cross-sectional view of the embodiment of the electrode assembly shown in FIG. 5.

FIG. 7 is a perspective view of another embodiment of the invention.

FIG. 8 in a cross-sectional view of the embodiment of the invention shown in FIG. 7.

FIG. 9 is a partial cross-sectional view of the embodiment of the invention shown in FIG. 8 depicting the electrode assembly connection to the bus bars and bus plate.

FIG. 10 is a partial cross-sectional view of the embodiment of the invention shown in FIG. 7 depicting the junction box and conducting electrode in connection with the bus plate.

FIG. 11 is a cross-sectional view of another embodiment of the invention depicting the electrode assemblies as including spaced-apart electrode plates.

### DETAILED DESCRIPTION OF PREFERRED EMBODIMENTS

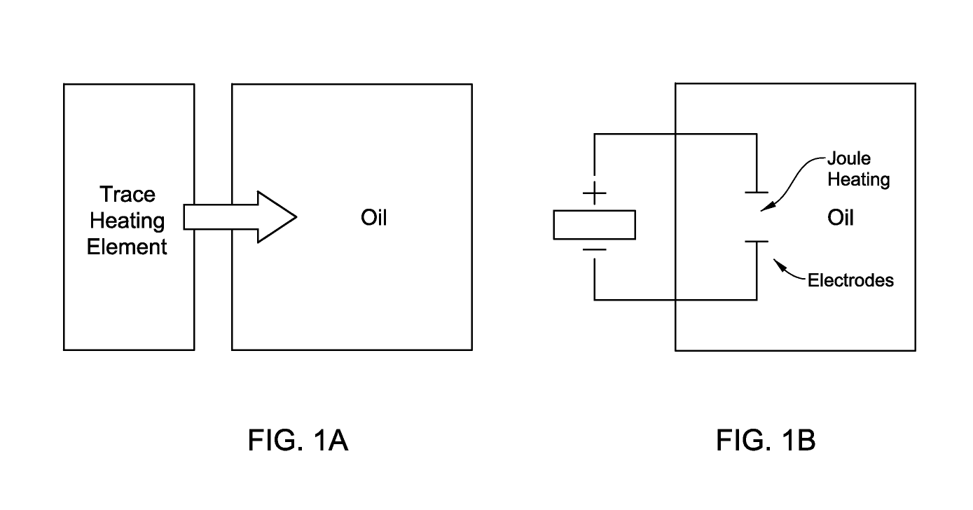

The heating principle employed by apparatus 10 is referred to as “Joule” heating. Joule heating has a number of advantages over other forms of heating typically used with respect to fluid such as crude oil. These other forms of heating may include bulk heating with natural gas or electrical trace heating (shown in FIG. 1A). Using electrical power to heat has advantages in terms of convenience onboard ships, low emissions in the field (compared to natural gas), and can be transmitted efficiently using electrical power lines. Joule heating is more efficient at converting electrical energy to internal energy in oil, compared to electrical trace heating. Joule heating is about 74% efficient. This value can be increased substantially by optimal design parameters. In comparison, typical efficiencies for tracing heating are about 30%.

The Joule heating technique (described in FIG. 1B) applies “electrical work” to the oil, instead of generating the heat in a resistive heater and then conducting heat into the oil using a thermal gradient (described in FIG. 1A). Electrical work through Joule heating is a significantly more efficient process. For example, crude oil can have a widely varying thermal conductivity, but is typically low, as for example, kₒᵢₗ˜0.147 W/(m K), which is about ⅕^{th} of that of water, and about two to three orders of magnitude lower than many common metals. Trace heating relies on using an electrical resistor (A.1) to heat up, and then heat is conducted from the resistor (A.1) into the fluid (A.2). Because of the low thermal conductivity of oil, it is difficult to get the heat to penetrate significantly into the oil. A large fraction of the heat can easily conduct into the metal pipeline material and be transferred to the surrounding environment.

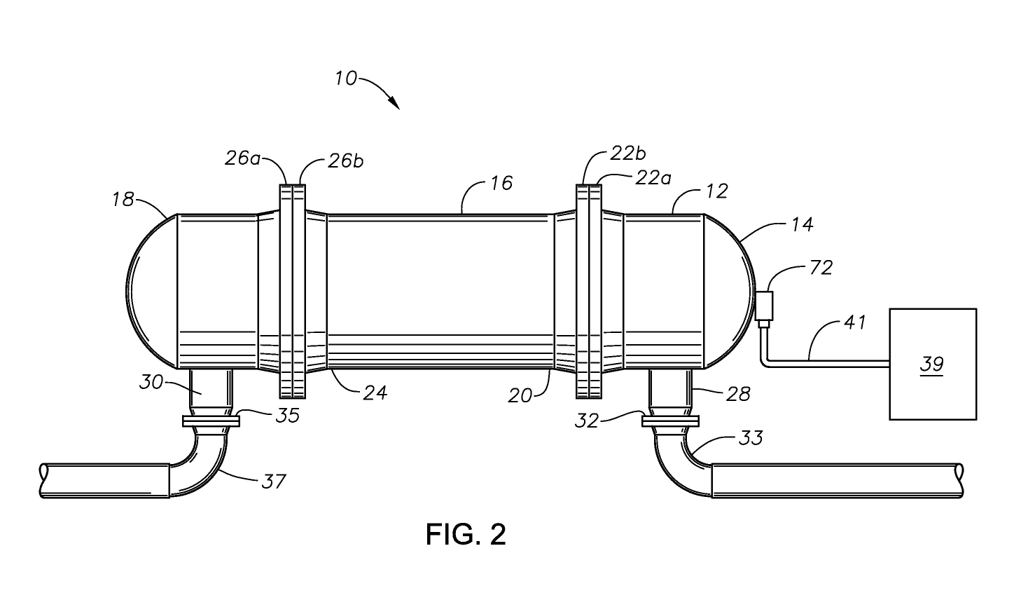

FIG. 2 shows an embodiment of heating apparatus 10. Apparatus 10 may include housing 12. Housing 12 may include inlet section 14, heating section 16, and outlet section 18. Inlet section 14 may be detachably connected to end 20 of heating section 16 by flanges 22a, 22b. Outlet end 18 may be detachably connected to end 24 of heating section 16 by flanges 26a, 26b. When assembled, inlet section 14, heating section 16, and outlet section 18 may be in fluid communication.

With reference to FIG. 2, inlet section 14 may include inlet portal 28. Outlet section 18 may include outlet portal 30. Inlet portal 28 may include flange 32 for detachably connecting inlet portal 28 to inlet conduit 33 for flowing oil into apparatus 10 via inlet portal 28. Outlet portal 30 may include flange 35 for detachably connecting outlet portal 30 to outlet conduit 37 for flowing heated oil out of apparatus 10 via outlet portal 30. Electrical power source 39 may be provided to supply electric power (e.g., an electric current) through electrical conduit 41 to apparatus 10.

Housing 12 may be formed in a variety of shapes and dimensions. For example, as seen in FIG. 2, housing 12 may be cylindrically shaped. Housing 12 may have a length of 5′8″, a width of 3′4″, and a height of 3″6″ as mounted. Inlet and outlet portals 28, 30 may each have a 24″ pipe body. Housing 12 may be formed of a variety of materials such as metal, as for example, structural steel or carbon steel.

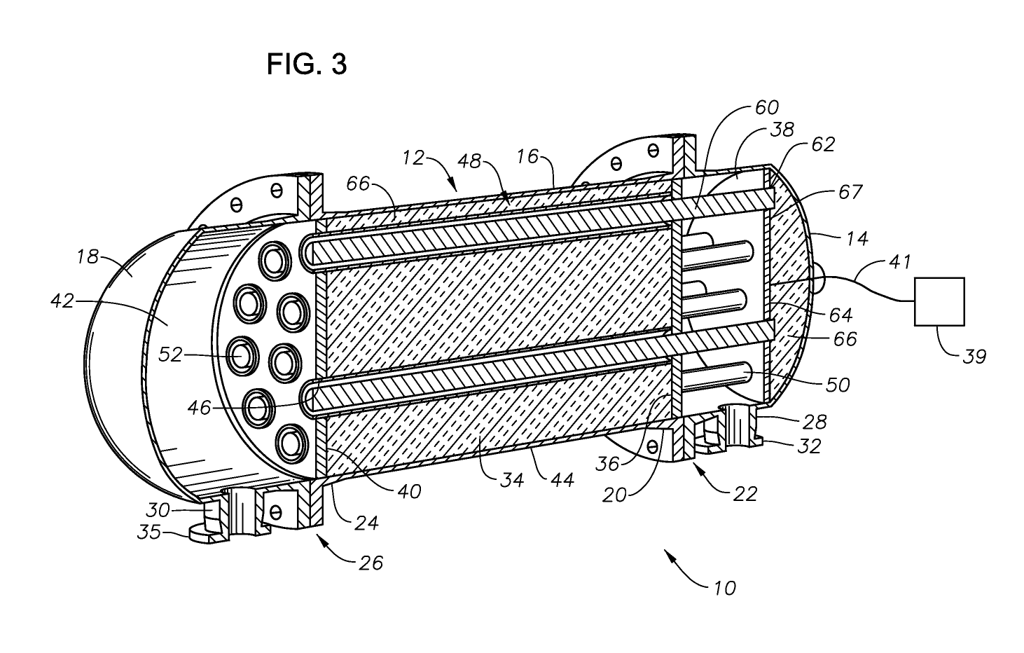

With reference to FIG. 3, housing 12 may include internal cavity 34. Internal cavity 34 may be divided into compartments. For example, first support member 36 may be transversely positioned at end 20 of heating section 16 to form internal inlet section 38. Second support member 40 may be transversely positioned at end 24 of heating section 16 to form internal outlet section 42. Support members 36, 40 also may form internal heating section 44.

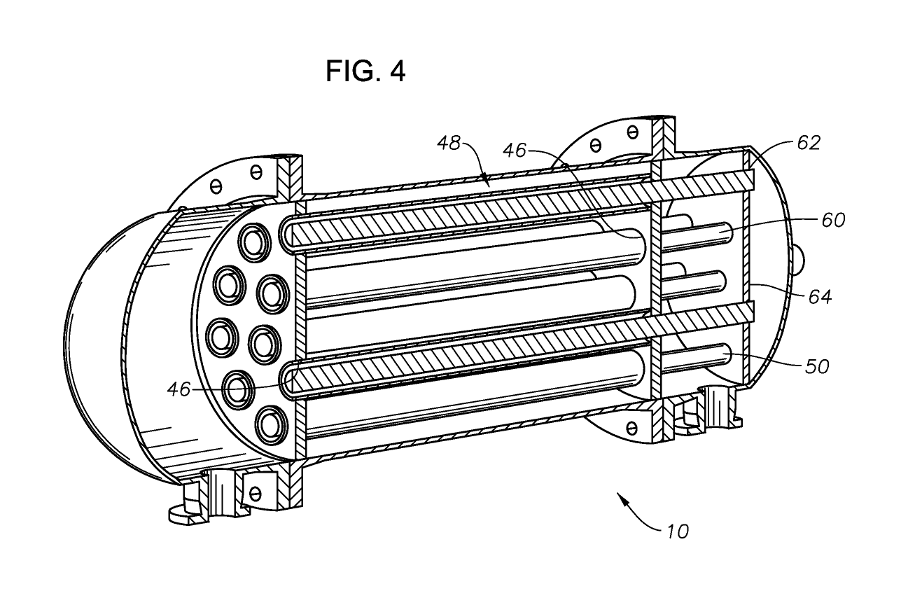

As seen in FIGS. 3 and 4, each of support members 36, 40 may include one or more openings or bores 46. Each of opening 46 in support member 36 may be axially aligned with a corresponding opening 46 in support member 40. Each opening 46 in support member 36 and its axially aligned corresponding opening 46 in support member 40 may receive and support one electrode assembly 48.

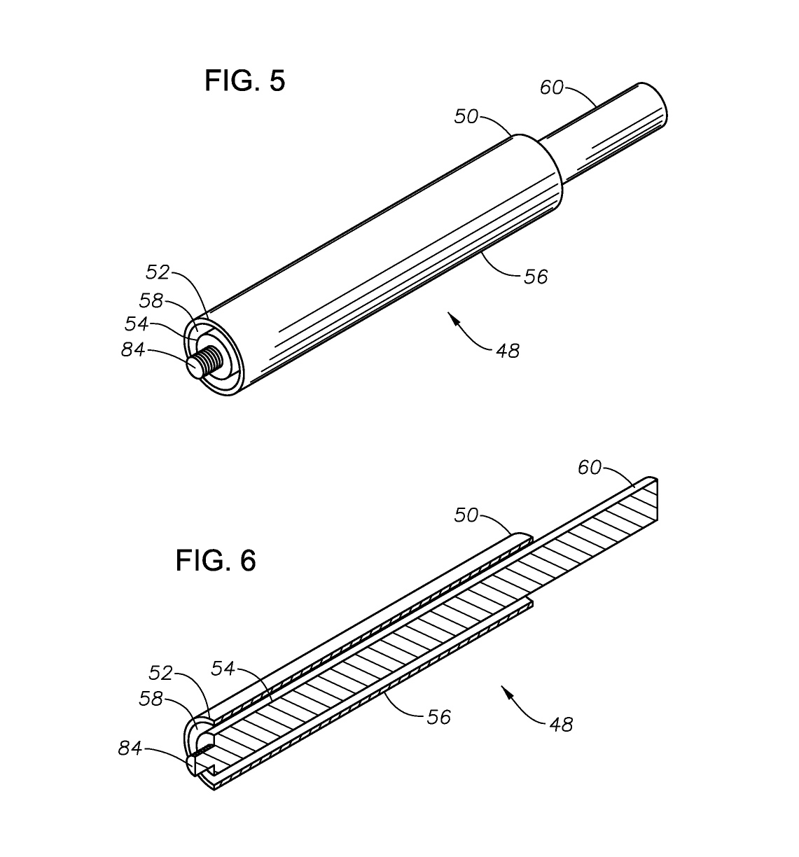

With reference to FIGS. 5 and 6, electrode assembly 48 may include distal end 50 and proximal end 52. Electrode assembly may include inner electrode 54 and outer electrode 56 in spaced relation to form annulus 58. For example, outer electrode 56 may be tubular-shaped (e.g., tubular or a tube) with inner electrode 54 concentrically placed within electrode 56 to form annulus 58. Outer electrode 56 may have a length in the range of 1 to 360 inches and an inner diameter in the range of 2 to 24 inches Inner electrode 54 may have a length in the range of 1 to 360 inches and a diameter of 1/16″ to 24 inches. The space between the outer surface of inner electrode 54 and the inner surface of outer electrode 56 that forms annulus 58 may be in the range of 1/16″ to 24 inches. Each of inner and outer electrodes 54, 56 may be made of conductive metal, as for example, stainless steel.

Apparatus 10 may include one or more electrode assemblies 48. For example, apparatus 10 may include from one to 700 electrode assemblies. The embodiment of apparatus 10 shown in FIG. 3 includes 16 electrode assemblies 48.

Again with reference to FIGS. 3 and 4, proximal end 52 of each electrode assembly 48 is accommodated within and supported by opening 46 in support member 40 and distal end 50 is accommodated within and supported by the corresponding axially aligned opening 46 in support member 36. Distal extend 60 of each inner electrode 54 extends past support member 36 and protrudes into internal inlet section 38 terminating at connection point 62. Each connection point 62 is operatively connected to bus bar 64 positioned transversally within internal inlet section 38. Bus bar 64 may be in electrical communication with electrical power source 39. Electrical power source 39 may supply electric power (e.g. an electric current) through electrical conduit 41 to bus bar 64. Electrical conduit 41 may, for example, be an electrode. Bus bar 64 and conduit 41 may be made of any electrical conductive material, as for example, brass.

With respect to FIG. 3, internal inlet section 38 may include an insulating material 66. For example, material 66 may be placed or contained in the portion of internal inlet section 38 from and to the right of bottom surface 67 of bus bar 64. Internal heating section 44 may also include material 66. Material 66 may be distributed around the portion of each electrode assembly 48 that is longitudinally positioned within internal heating section 44. Material 66 may function to provide insulation within internal inlet section 38 about bus bar 64 and within internal heating section 44 about electrode assemblies 48. Material 66 may prevent or retard the transfer of heat generated by bus bar 64 and electrode assemblies 48 to housing 12. Material 66 may be composed any material that provides insulating properties. For example, material 66 may be a polyurethane.

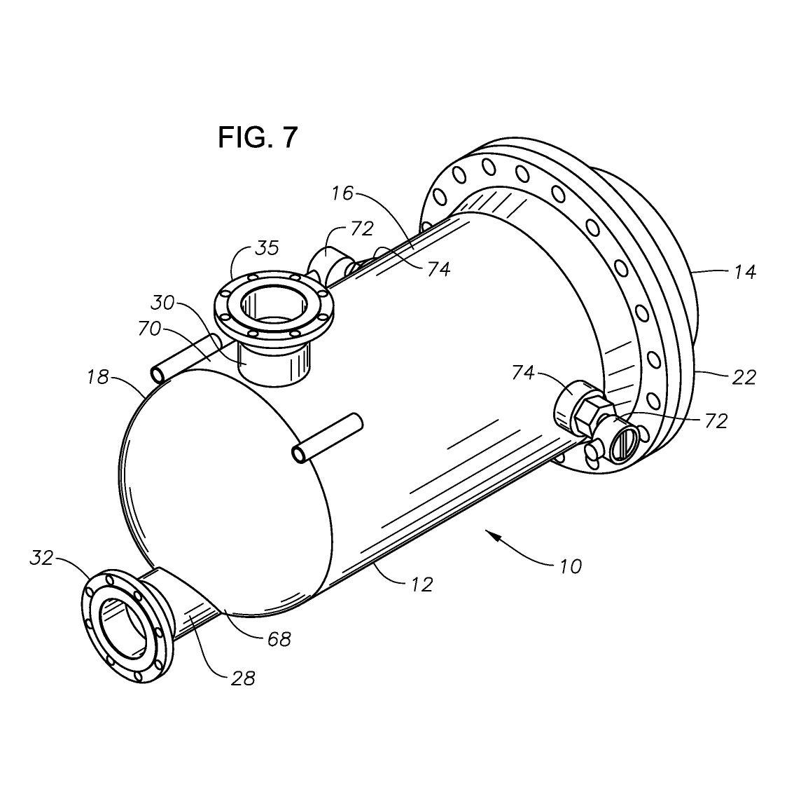

Another embodiment of apparatus 10 is depicted in FIGS. 7-10. In this embodiment (as shown in FIG. 7), outlet section 18 may be made uniform or integral with heating section 16. Inlet portal 28 may be positioned at bottom section 68 of housing 12. Outlet portal 30 may be positioned at top section 70 of housing 12. Electrical junction boxes 72 may be positioned on each side 74 of heating section 16. The electrical power source 39 (not shown) that provides electric current to apparatus 10 supplies the electric current through an electric conduit 41 (not shown) that is detachably affixed to each of electrical junction boxes 72. With the displacement of inlet portal 28 to bottom section 68, inlet section 14 may be more accurately described as vessel cap section 14. It is to be understood that the placement of inlet and outlet portals 28, 30 and junction boxes 72 about housing 12 may vary without detracting from the functionality of apparatus 10.

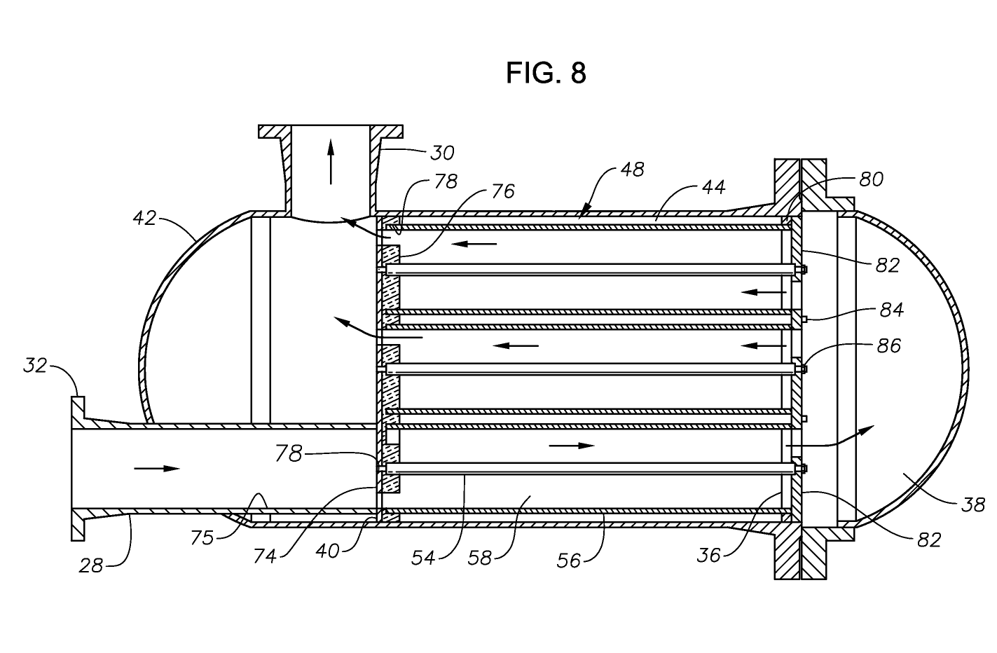

With reference to FIG. 8, inlet portal 28 extends into internal outlet section 42 via internal pipe 75. The end of internal pipe 75 may be engaged to seal to support member 40 about an opening 46 therein such that fluid entering into apparatus 10 through inlet portal 28 flows, via internal pipe 75, through opening 46 and into annulus 58 of one of electrode assemblies 48. The fluid flows through annulus 58 where an electric current may be passed through the fluid from inner electrode 54 (the supply electrode or anode) to the outer electrode 56 (the ground electrode or cathode) causing the fluid to be heated. The heated fluid flows in a first axial direction (e.g., in a left to right direction) through annulus 58 of the electrode assembly 48 and exits through the corresponding axial opening 46 in support member 36 where the heated fluid is deposited within the internal inlet section 38. Internal inlet section 38 may be better described as internal cap section 38. From internal cap section 38, the heated fluid will flow into the annulus 58 of any other electrode assemblies 48 within internal heating section 44 by passing through opening 46 in support member 36 associated with the particular electrode assembly 48. The heated fluid will then flow in a second direction (e.g., in a right to left direction) through annulus 58 of the respective electrode assembly 48 and undergo further heating as a result of the electric field created by inner electrode 54 and outer electrode 56. The additionally heated fluid will exit through the corresponding axially positioned opening 46 in support member 40 where the additionally heated fluid will be deposited within internal outlet section 42. The additionally heated fluid will then flow from internal outlet section 42 through outlet portal 30 and into outlet conduit 37 (not shown). In this embodiment, apparatus 10 does not include insulating material 66 within internal heating section 44 and internal inlet or cap section 38.

Again with reference to FIG. 8, support member 40 may be configured as an assembly including internal ring member 74 and insulating support piece 76. Internal ring member 74 may be made of any structural material capable of supporting electrode assemblies 48. Internal ring member 74 may, for example, be made of metal. Insulating support piece 76 may be detachably affixed to the underside of internal ring member 74. For example, insulating support piece 76 may be bolted to internal ring member 74. Insulating support piece 76 may contain preformed supporting recesses 78 that accommodate and support the proximal ends 52, 84 of electrode assemblies 48.

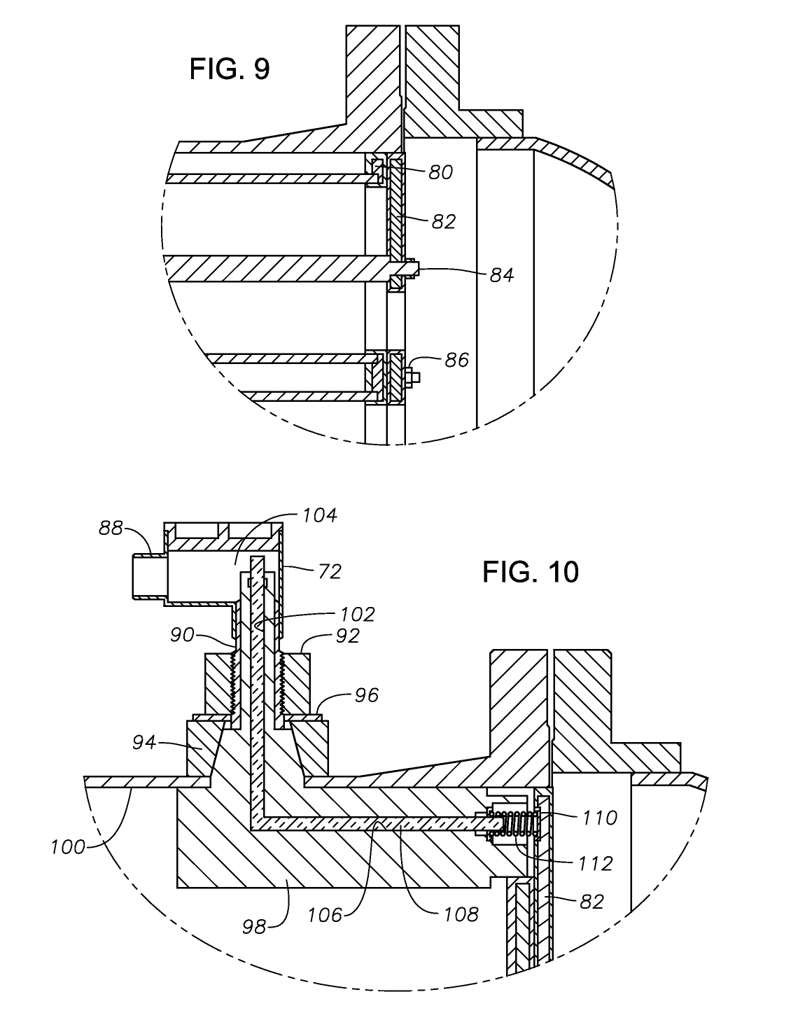

As illustrated in FIGS. 8 and 9, support member 36 may be configured as an assembly including ground bus bars 80 and bus plate 82. Grounds bus bars 80 and bus plate 82 may be insulated with an insulating material, as for example, a polyurethane coating. Distal end 50 of electrode assemblies 48, namely, each of the outer electrodes 56 may be directly welded to respective insulated ground bus bars 80. The distal end 60 of each inner electrode 54 may be operatively connected to insulated bus plate 82. For example, distal end 60 of each inner electrode 54 may be bolted to insulated bus plate 82 by bolts 86. The operative connection of each inner electrode 54 to insulated bus plate 82 enables electric current traveling to insulated bus plate 84 via power source 39 to be transferred to each of inner electrodes 54 where the current then passes to the outer electrode 56 within the annulus 58 thereby causing electric work on the fluid within annulus 58 leading to an increase in temperature of the fluid. Both insulated ground bus bars 80 and insulated bus plate 82 may be insulated with any type of material that provides insulation, as for example, a polyurethane coating. This embodiment may use any number of electrode assemblies depending on a variety of factors, as for example, the size of housing 12, the voltage applied to electrode assemblies 48, and the flow rate of the fluid being processed by apparatus 10. For example, seven electrode assemblies may be used.

FIG. 10 depicts an embodiment of the configuration of junction box 72 and its electrical connection to insulated bus bar plate 82. Junction box 72 may include electrical housing 88 inserted over and affixed to over-molded metal part 90 which may contain external threads. Over-molded metal part 90 may be secured to external mount 94. Compression nut 92 may be threadedly connected to over-molded metal part 90 to detachably secure housing 88 to external mount 94. Teflon washer 96 may be included. The threaded connection of compression nut 92 causes compression against the insulated overmold 98, causing sealing engagement of the insulated overmold 98 against the internal angled wall of the external mount 94. Insulated overmold 98 (which may be L-shaped) may be positioned on the inner surface 100 of housing 12 and extend in one direction where terminates and abuts insulated bus plate 82. Insulated overmold 98 may extend in another direction external to housing 12 passing within bore 102 that extends through housing 12, mount 94, compression nut 90 and into internal cavity 104 of housing 88. Insulated overmold 98 may contain central bore 106 in which one or more conducting electrodes 108 are situated and extend from internal cavity 104 of housing 88 to insulated bus plate 82. At connection point 110, the end of conducting electrode 108 may be operatively connected to a non-insulating portion of insulated bus plate 82 such that electrical current may travel through conducting electrode 108 and be transported to insulated bus plate 82 at connection point 110. Electrode 108 may be connected to insulated bus plate 82 via spring assembly 112. Electrode 108 may be made of brass.

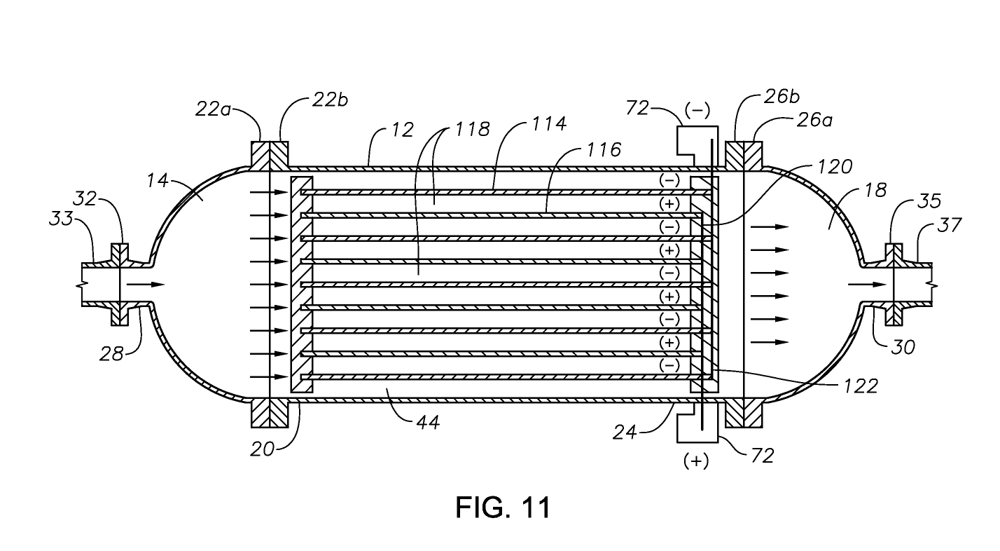

FIG. 11 depicts an alternative embodiment apparatus 10. Electrode assemblies 48 may each comprise ground plate electrode 114 parallel to and spaced-apart from supply plate electrode 116. The fluid flows from inlet portal and into space 118 between each ground plate electrode 114 and supply plate electrode 116. In space 118, the fluid is subjected to the electric current flowing from supply plate electrode 116 to ground plate electrode 114 resulting in the heating of the fluid. Bus bar plate 120 transfers electric current to each supply plate electrode 116. Grounding bus bar plate 122 receives current passing through the fluid from each ground plate electrode 114. Ground plate electrodes 114 and supply plate electrodes 116 may be positioned parallel to a direction of flow of the fluid through space 118. Ground plate electrodes 114 and supply plate electrodes 116 may be positioned in a horizontal orientation, a vertical orientation, or any orientation therebetween.

In operation, fluid (e.g., mildly-conductive fluid, crude or refined oil, or by-products of crude oil) may be transported through inlet portal 28 where the fluid flows (via pressure gradient) into one or more electrode assemblies via annulus 58. While flowing through annulus 58, electrical power source 39 is activated to supply an electrical current, through electrical conduit 41, to bus bar 64, which transfers the electric current to inner electrodes 54. The “hot” inner electrode 54 transfers the electric current to the fluid flowing through annulus 58 thereby heating the fluid. Each outer electrode 56 acts a ground member. Heated fluid exits annulus 58 at proximal end 52 of electrode assembly 48 and flows into internal outlet section 42. From internal outlet section 42, the heated fluid flows through outlet portal 30 and into conduit 37 where the heated fluid is transported, for example, through a pipeline system.

With apparatus 10, an intense electric field is applied to the oil. Due to the small, but finite oil electrical conductivity, electrical work is applied predominantly to the oil, which increases the internal energy of the oil. The increase in internal energy is observed as an increase in oil temperature.

Because Joule heating is applied through electrical work to the oil, instead of transferring heat through conduction, there is less entropy generated, for a given increase in internal energy of the oil. The result is that oil can be heated with less contact time between the oil and the heating apparatus 10. This in turn can reduce the length of the heating apparatus 10, or can allow for higher flow rates of oil through the apparatus 10.

With apparatus 10, the electrical field is delivered to the oil using two concentric annular electrodes 54, 56. In between the electrodes, is an annular region 58, where the oil flows axially. The annular region 58 can be designed such that the Joule heating is substantially uniform, which allows the oil to be heated substantially uniformly. This is much more advantageous than trace heating, where heat is transferred at the boundaries, and is not uniform.

The cylindrical electrode design and annular oil flow region is designed to apply an intense electric field to the oil, without significant pressure drop. In addition, the design is relatively easy to manufacture and at a relatively low cost. A 5.5 psi pressure drop may be required to push 100 gallons of oil per minute through the apparatus 10, assuming the oil has a dynamic viscosity of μ=3.85 Pa s. This design can be further optimized within the guidelines of the claims to increase efficiency.

The voltage applied to inner electrode 54 may vary. For example, a voltage of 0-10000 V may be applied to inner electrode 54. More preferably, a voltage of 8000 V may be applied to inner electrode 54. 0V may be applied to outer grounding electrode 56.

Because the electrical conductivity of the oil is about 12 orders of magnitude lower than that of the electrodes 54,56, nearly all the electric field will reside in oil annulus 58. Here, Joule heating is given by \dot{Q}ₑ=σ|E|², where |E| is the magnitude of the electric field. The oil in annulus 58 is represented as \dot{Q}ₑ˜3×10⁵ [W/m³]. In the electrodes 54, 56, Joule heating is 10 orders of magnitude lower at approximately \dot{Q}ₑ˜9×10⁻⁶ [W/m³] and 7 orders of magnitude greater than what occurs in the bus bar.

With a flow rate of 100 gallons per minute the maximum velocity is indicated by Uₘₐₓ=0.174 m/s.

A large voltage drop (i.e. electric field) may occur in the oil annulus.

Very little Joule heating occurs in bus bar 64 and electrodes 54, 56 (7-10 orders of magnitude lower than in the oil), because oil is such a poor thermal conductor. It is very inefficient for the oil to convect heat away from the bus bar 64 and electrodes 54, 56. As a result, the bus bar 64 heats up to about 12° C. above ambient conditions of T_{amb}=0° C. The inner electrodes 54 heat up to about 7° C. above ambient.

Inner electrodes 54 reach a temperature of 1-50° C. above ambient, but do not contribute to heating of the oil. Bulk material 66 to the right of the bus bar 64 may reach a temperature of 50° C. above ambient. This is due to Joule heating of the bulk material 66 (e.g., polyurethane) that occurs between the bus bar 64 and the surrounding pipe material. Poor thermal conduction of the bulk material will allow the temperature to become high; however, this does not heat the oil, but instead can create some inefficiency due to thermal losses to the surrounding pipe material and surrounding environment. This can be improved by different material choices and placing the bus bar 64 further away from the pipe housing.

The oil temperature at the outlet reaches 0.1-30° C. above the inlet and ambient oil temperatures. The heating is achieved using V_{applied}=8000 V. When the electrical conductivity is σ=1×10⁻⁶ S/m, the draw is I=2.96 A. The rate of electrical work applied to the apparatus is therefore, \dot{W}=23.68 [kW].

The oil in annulus 58 has a heat flux of q″=7×10⁷ [W/m²], which is 50,000 times higher than the heat flux through the electrode 54.

The oil has an inlet temperature of Tᵢₙ=0° C. and an outlet temperature Tₒᵤₜ=3° C. The velocity profile of the annular region 58 may have a maximum velocity of 0.172 m/s.

The total rate of energy transfer flux of oil at 100 gallons per minute entering the Joule heating apparatus 10 is ink \dot{m}hᵢₙ=2.7765×10⁶ [W], where \dot{m} is the mass flow rate and hᵢₙ is the specific enthalpy of oil at the inlet. The oil is heated by 3° C. in the apparatus 10. The total rate of energy transfer at the outlet is \dot{m}hₒᵤₜ=2.7789×10⁶ [W]. The net change in enthalpy is therefore \dot{m}(hₒᵤₜ−hᵢₙ)=17.4 [kW]. Alternatively, the oil may enter the Joule heating apparatus 10 at a rate of 1-1000 gallons per minute.

Joule heating is achieved using V_{applied}=8000 V. When the electrical conductivity is σ=1×10⁶ S/m, the current draw is I=2.96 A. The rate of electrical work applied to the apparatus 10 is therefore, \dot{W}ₑ=23.68 [kW]. As a result, the thermodynamic efficiency of the

$$system is η ≡ \frac{\dot{m} ( {h}_{out} - {h}_{i n} )}{{\dot{W}}_{e}} = \frac{17.4 [ kW ]}{23.68 [ kW ]} = 73.5 \% .$$

Apparatus 10, which employs direct fluid electric heat transfer or Joule Heating, achieves multiple benefits for the production, transportation, and storage of petroleum products through the direct application of electrical potential to the fluid. The desired benefits include, for example, the lowering of viscosity, prevention of paraffin deposition, efficient heat transfer, destruction of living biomass such as bacteria, and water molecule aggregation facilitating separation. Apparatus 10 will make transportation by pipeline, tanker truck, tanker train and marine crude carrier more efficient, more economical, and with increased margins of safety. This list is meant to be illustrative. Although the present invention has been described in considerable detail with reference to certain preferred versions thereof, other versions are possible. Therefore, the spirit and scope of the appended claims should not be limited to the description of the preferred versions contained herein.

What is claimed is:

1. A Joule heating apparatus comprising a housing including an internal cavity, an inlet portal for introducing a fluid into the internal cavity, and an outlet portal for discharging the fluid from the internal cavity, the internal cavity including an internal heating section, the internal heating section including at least one electrode assembly, the at least one electrode assembly including a supply electrode, a ground electrode, and a space between the supply and ground electrodes, the space being in fluid communication with the inlet and outlet portals, the at least one electrode assembly adapted to form an electric field to heat via Joule heating the fluid flowing through the space, wherein the fluid is substantially composed of crude oil flowing in a pipeline.

2. The apparatus of claim 1, further comprising an electrical power source for supplying an electric current to the at least one electrode assembly.

3. The apparatus of claim 2, wherein the supply electrode is adapted to receive the electric current from the electrical power source and the ground electrode is adapted to act as a grounding member.

4. The apparatus of claim 1, wherein the supply electrode is formed of a supply plate and the ground electrode is formed of a ground plate, wherein the supply plate and the ground plate are positioned parallel to a direction of flow of the fluid through the space between the supply and ground electrodes.

5. The apparatus of claim 4, further comprising an electrical power source for supplying an electric current to the at least one electrode assembly.

6. The apparatus of claim 5, wherein the supply plate is adapted to receive the electric current from the electrical power source and the ground plate is adapted to act as a grounding member.

7. The apparatus of claim 6, further comprising a plurality of supply plates and a plurality of ground plates arranged in an alternating pattern within the internal heating section, wherein the supply plates and the ground plates are positioned parallel to the direction of flow of the fluid through the space, wherein a space between each supply plate and each ground plate is substantially equal.

8. The apparatus of claim 7, wherein the internal cavity further includes one or more bus bars adapted to be in operative electrical connection with the electrical power source, and wherein each of the plurality of supply plates is in electrical connection with one of the bus bars.

9. The apparatus of claim 8, wherein the internal cavity further includes one or more grounding bus bars, and wherein each of the plurality of ground plates is in electrical connection with one of the grounding bus bars.

10. A Joule heating apparatus comprising a housing including an internal cavity, an inlet portal for introducing a fluid into the internal cavity, and an outlet portal for discharging the fluid from the internal cavity, the internal cavity including an internal heating section, the internal heating section including at least one electrode assembly, the at least one electrode assembly including an outer electrode, an inner electrode, and an annulus between the inner and outer electrodes, the annulus being in fluid communication with the inlet and outlet portals, the at least one electrode assembly adapted to form an electric field to heat via Joule heating the fluid flowing through the annulus, wherein the fluid is substantially composed of crude oil flowing in a pipeline.

11. The apparatus of claim 10, wherein the outer electrode is tubular and the inner electrode is concentrically positioned within the outer electrode for axially flow of the fluid through the annulus.

12. The apparatus of claim 11, further comprising an electrical power source for supplying an electric current to the at least one electrode assembly.

13. The apparatus of claim 12, wherein the inner electrode is adapted to receive the electric current from the electrical power source and the outer electrode is adapted to act as a grounding member.

14. The apparatus of claim 13, wherein the internal heating section is defined by a first support member transversely positioned within the internal cavity and a second support member transversely positioned within the internal cavity.

15. The apparatus of claim 14, wherein the internal heating section includes a plurality of electrode assemblies and wherein the first and second support members each includes a plurality of openings, each opening in the first support member being in axial alignment with an opening in the second support member for receiving and supporting one of the plurality of electrode assemblies.

16. The apparatus of claim 15, wherein the internal cavity further includes one or more bus bars adapted to be in operative electrical connection with the electrical power source and wherein the plurality of electrode assemblies are each in electrical connection with one of the bus bars.

17. The apparatus of claim 16, wherein the inner electrode of each of the plurality of electrode assemblies is in electrical connection with one of the bus bars.

18. The apparatus of claim 16, wherein the internal cavity further includes one or more grounding bus bars and wherein the outer electrode of each of the plurality of electrode assemblies is in electrical grounding connection with one of the grounding bus bars.

19. The apparatus of claim 10, wherein the internal cavity further includes an internal pipe providing fluid communication between the inlet portal and the at least one electrode assembly.

20. The apparatus of claim 14, wherein the first support member includes an internal ring member having attached thereto an insulating support piece, the insulating support piece including a plurality of preformed recesses that accommodate and support a proximal end of the at least one electrode assembly.

21. The apparatus of claim 20, wherein the second support member includes one or more grounding bus bars and a bus plate and wherein a distal end of the outer electrode of the at least one electrode assembly is affixed to one of the grounding bus bars and a distal end of the inner electrode of the at least one electrode assembly is detachably affixed to the bus plate.

22. The apparatus of claim 21, wherein the one or more grounding bus bars and the bus plate are insulated with an insulating material.

23. The apparatus of claim 10, wherein the fluid is selected from the group consisting of mildly-conductive fluid, a crude oil, a by-product of crude oil, and a refined oil.

24. A method for Joule heating of a fluid comprising the steps of:
a) providing a Joule heating apparatus comprising a housing including an internal cavity, an inlet portal for introducing the fluid into the internal cavity, and an outlet portal for discharging the fluid for the internal cavity, the internal cavity including an internal heating section, the internal heating section including at least one electrode assembly, the at least one electrode assembly including a supply electrode, a ground electrode, and a space between the supply and ground electrodes, the space being in fluid communication with the inlet and outlet portals, the at least one electrode assembly adapted to form an electric field to heat via Joule heating the fluid flowing through the space; and an electrical power source for supplying an electric current to the at least one electrode assembly;
b) flowing the fluid through the inlet portal and into the internal cavity of the housing, wherein the fluid is substantially composed of crude oil flowing in a pipeline;
c) flowing the fluid through the space of the at least one electrode assembly;
d) causing the electrical power source to supply the electric current to the at least one electrode assembly to form the electric field to heat the fluid flowing through the space of the at least one electrode assembly;
e) flowing the heated fluid from the space of the at least one electrode assembly through the outlet portal.

25. The method of claim 24, wherein in step (d) the electric charge is supplied to the supply electrode of the at least one electrode assembly and the ground electrode of the at least one electrode assembly grounds the electric charge as it passes through the fluid in the space.

26. The method of claim 25, wherein in step (d) the electric charge supplied to the supply electrode of the at least one electrode assembly is 0-10000 V.

27. The method of claim 26, wherein in step (d) the supply electrode of the at least one electrode assembly reaches a temperature of 1-50 degrees C. above ambient temperature without contributing to the heating of the fluid.

28. The method of claim 26, wherein in step (f) the heated fluid exits through the outlet portal at a temperature that is 0.1-30 degrees C. above an ambient temperature of the fluid as it flowed through the inlet portal.

29. The method of claim 24, wherein in step (c) the fluid flows through the space of the at least one electrode assembly at a rate of 1-1000 gallons per minute.

30. The method of claim 24, wherein the heating section includes a plurality of electrode assemblies.

31. The method of claim 30, wherein the internal cavity further includes an internal pipe providing fluid communication between the inlet portal and one of the plurality of electrode assemblies.

32. The method of claim 31, wherein in steps (b) and (c) the fluid flows from the inlet portal through the internal pipe and through the space of one of the plurality of electrode assemblies in a first direction and is subjected to an electric charge causing heating of the fluid.

33. The method of claim 32, wherein the heated fluid is discharged from the space of one of the plurality of electrode assemblies and flows through the space of one of the other plurality of electrode assemblies in a second direction and is subjected to an electric charge causing additional heating of the fluid.
